(19) United States
(12) Patent Application Publication
(10) Pub. No.: US 2026/0120586 A1
(43) Pub. Date: Apr. 30, 2026

(54) METHOD AND SYSTEM FOR ASSESSING ANSWERING ABILITY FROM A HANDWRITTEN ANSWER SHEET FOR MATHEMATICS AND PHYSICS TEST QUESTIONS

(71) Applicant: MetaMath CO., LTD., Taipei City (TW)

(72) Inventors: Tseh-Shun CHERN, Taipei City (TW); Mao-Ching CHIU, Taipei City (TW); Guan-Wei LI, Taipei City (TW)

(21) Appl. No.: 19/368,229

(22) Filed: Oct. 24, 2025

(30) Foreign Application Priority Data
Oct. 28, 2024 (TW) 113141148

(51) Int. Cl. G09B 7/02; G06V 30/19

(52) U.S. Cl. CPC G09B 7/02; G06V 30/19

(57) ABSTRACT

A method and system for assessing answering ability from a handwritten answer sheet for mathematics and physics test questions are provided. The method has steps of: obtaining a student's handwritten answer sheet for mathematics and physics test questions; identifying multiple first operational expressions of each question's answer content, an answering sequence thereof and a first answer; previously storing multiple detailed explanations of the mathematics and physics test questions, wherein each detailed explanation has multiple second operational expressions, an answering sequence thereof and a second answer; and scoring this test question if the first operational expressions of one test question and the answering sequence thereof matches the second operational expressions of the same test question and the answering sequence thereof of one of the detailed explanations.

### CROSS-REFERENCE TO RELATED APPLICATIONS

This application is based upon and claims priority under 35 U.S.C. 119 from Taiwan Patent Application No. 113141148 filed on Oct. 28, 2024, which is hereby specifically incorporated herein by this reference thereto.

### BACKGROUND OF THE INVENTION

### 1. Field of the Invention

The present invention relates to an answer sheet problem-solving ability assessment system, and more particularly to a method and system for assessing answering ability from a handwritten answer sheet for mathematics and physics test questions.

### 2. Description of the Prior Arts

Currently, the most widely accepted and least disputed automatic grading method is to use a 2B pencil to fill in an answer card, which is then read by a machine to recognize, read, and determine whether the answers are correct, as this method has the highest accuracy. However, since the answer positions for multiple questions on the card are fixed and only allow filling by hand-drawn marks, this method cannot be applied to the automatic grading of handwritten answer sheets for calculation or essay-type questions.

For subjects related to mathematics and physics, answer sheets are mostly completed by handwriting. At present, so-called automatic grading of handwritten answer sheets remains at the stage of converting paper-based answer sheets into electronic image files, which only facilitates teachers in grading with computers. The development of systems capable of fully automatic grading of handwritten answer sheets still requires further advancement.

### SUMMARY

In view of the fact that handwritten answer sheets for mathematics and physics are mostly graded manually, which is time-consuming, labor-intensive, and incapable of effectively monitoring students' learning progress, the main objective of the present invention is to provide a method and system for assessing answering ability from a handwritten answer sheet for mathematics and physics test questions.

To achieve the main object, a method for assessing answering ability from a handwritten answer sheet for mathematics and physics test questions is provided, which is implemented by a computer device executing the following steps of:
(a) obtaining a handwritten answer sheet for mathematics and physics test questions, wherein the handwritten answer sheet includes an answer content corresponding to each question, and the answer content includes multiple first operational expressions and at least one first answer;
(b) identifying the first operational expressions corresponding to each question on the handwritten answer sheet, an answering sequence of the first operational expressions, and the first answer;
(c) reading at least one previously stored detailed explanation for the same question, wherein each detailed explanation includes multiple second operational expressions, a sequence of the second operational expressions, and at least one second answer, and when a single question includes multiple detailed explanations and multiple second answers, numbers of the second operational expressions are different or mathematical representation forms of the second operational expressions are different, and mathematical representation forms of the second answers are also different;
(d) comparing whether the first operational expressions and the answering sequence of the first operational expressions match the second operational expressions and the sequence of the second operational expressions of the at least one detailed explanation, and assigning an answering logic score for the question based on a comparison result; and
(e) comparing whether the first answer matches at least one second answer, and assigning an answer score for the question.

From the above description, the method for assessing answering ability from a handwritten answer sheet for mathematics and physics test questions mainly operates by obtaining a student's handwritten answer sheet, identifying, for each question, multiple first operational expressions, a relative answering sequence of the first operational expressions, and a first answer, and using in combination multiple previously stored detailed explanations corresponding to the question, wherein each detailed explanation includes multiple second operational expressions, an answering sequence of the second operational expressions, and at least one second answer in at least one answer form. Accordingly, when multiple identified first operational expressions and the relative answering sequence of the first operational expressions match multiple second operational expressions and the answering sequence of one detailed explanation, the question is assigned an answering logic score; and when an identified first answer matches at least one form of the second answer, the question is assigned an answer score. In this manner, the method effectively and objectively evaluates a student's true answering ability and records and monitors learning progress.

In another aspect, a system for assessing answering ability from a handwritten answer sheet for mathematics and physics test questions is provided and comprises:
an answer database configured to store, for each question in each test paper, at least one detailed explanation, wherein each detailed explanation includes multiple second operational expressions, a sequence of the second operational expressions, and at least one second answer, and when a single question includes multiple detailed explanations and multiple second answers, a number of the second operational expressions is different or a mathematical representation of the second operational expressions is different, and a mathematical representation of the second answers is also different;
a handwritten answer reading interface unit configured to read answer content of each question from a handwritten answer sheet for mathematics and physics test questions, and the answer content including multiple first operational expressions and a first answer; and
a computer device connected to the answer database and the handwritten answer reading interface unit, the computer device including an automatic grading program that executes steps of:
(a) receiving the answer content of each question from the handwritten answer reading interface unit;
(b) identifying the first operational expressions in the answer content, identifying an answering sequence of the first operational expressions, and identifying the first answer;
(c) reading at least one previously stored detailed explanation of the same question from the answer database;
(d) comparing whether the first operational expressions and the answering sequence of the first operational expressions match the second operational expressions and the answering sequence of the at least one detailed explanation, and assigning an answering logic score for the question based on a comparison result; and
(e) comparing whether the first answer matches the at least one second answer, and assigning an answer score for the question.

From the foregoing, the system for assessing answering ability from a handwritten answer sheet for mathematics and physics test questions primarily operates by previously storing, in an answer database, multiple detailed explanations corresponding to each question. After a student's handwritten answer sheet is obtained, multiple first operational expressions of each question, a relative answering sequence of the first operational expressions, and a first answer are identified. The system then compares the first operational expressions and the relative answering sequence with multiple second operational expressions and an answering sequence of one of the detailed explanations corresponding to the question, and assigns an answering logic score for the question based on a match. When the first answer is identified as matching one second answer, an answer score is further assigned for the question. In this manner, the system effectively and objectively evaluates a student's true answering ability, and records and monitors learning progress.

Other objectives, advantages and novel features of the invention will become more apparent from the following detailed description when taken in conjunction with the accompanying drawings.

### BRIEF DESCRIPTION OF THE DRAWINGS

FIG. 1 shows a schematic diagram of a system architecture of the method and system for assessing answering ability from a handwritten answer sheet for mathematics and physics test questions in accordance with the present invention;

FIG. 2 shows a schematic diagram of a handwritten answer sheet for mathematics and physics test questions in accordance with the present invention;

FIG. 3 shows a schematic diagram of the assessing answering ability assessment system identifying the first operational expressions and first answers in two handwritten answer sheets about mathematics and physics test questions in accordance with the present invention;

FIG. 4 shows a flowchart of the method for assessing answering ability from a handwritten answer sheet for mathematics and physics test questions in accordance with the present invention;

FIG. 5A shows a table of knowledge points corresponding to chapters in accordance with the present invention;

FIG. 5B shows a table of various learning ability level labels in accordance with the present invention;

FIG. 6A shows a table of matching rates and answer rates of various learning ability level labels counted based on the answer content in accordance with the present invention;

FIG. 6B shows a table of matching rates of cognitive ability level labels for all chapters involved in the questions, counted based on the answer content in accordance with the present invention; and

FIG. 6C shows a table of matching rates of the cognitive ability level label 2.2 annotated for all questions under different chapters, counted based on the answer content in accordance with the present invention.

### DETAILED DESCRIPTION OF THE EMBODIMENTS

The present invention provides a method and system for assessing answering ability from a handwritten answer sheet for mathematics and physics test questions, and the technical content is described in detail below with embodiments in conjunction with the drawings.

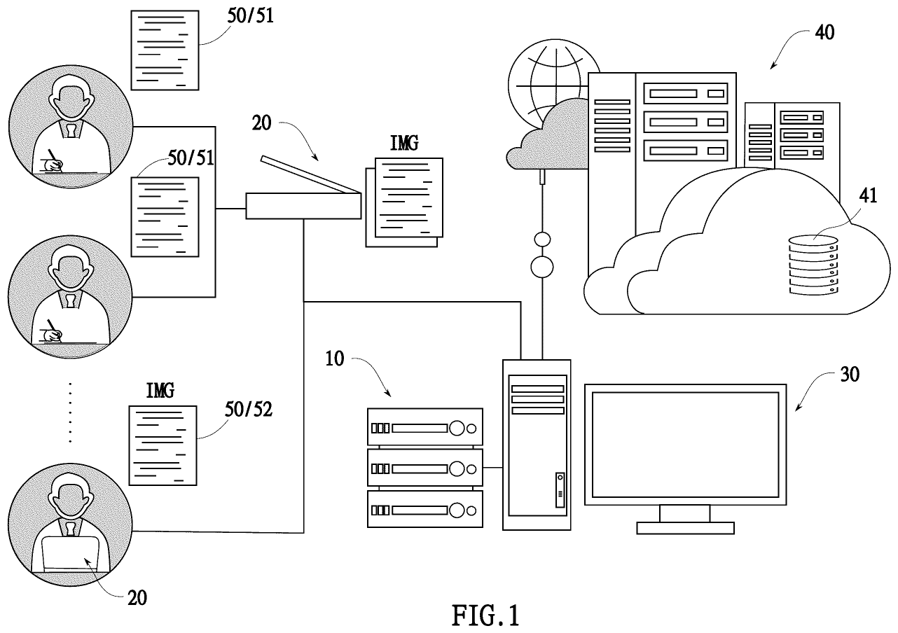

First, with reference to FIG. 1, which shows a schematic diagram of a system architecture of the assessing answering ability assessment system for the handwritten answer sheet 50 about mathematics and physics test questions in accordance with the present invention, comprising an answer database 10, a handwritten answer reading interface unit 20, and a computer device 30.

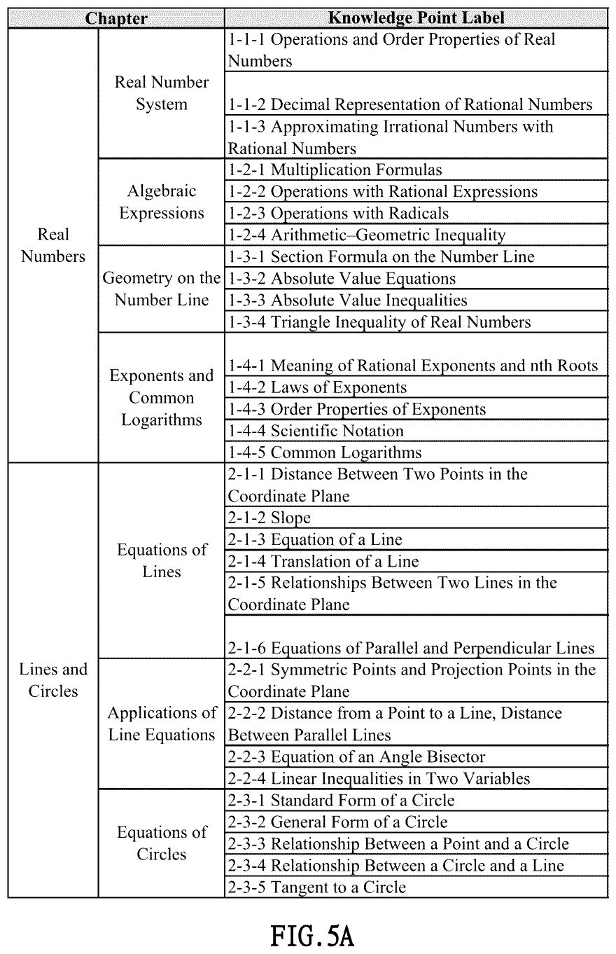

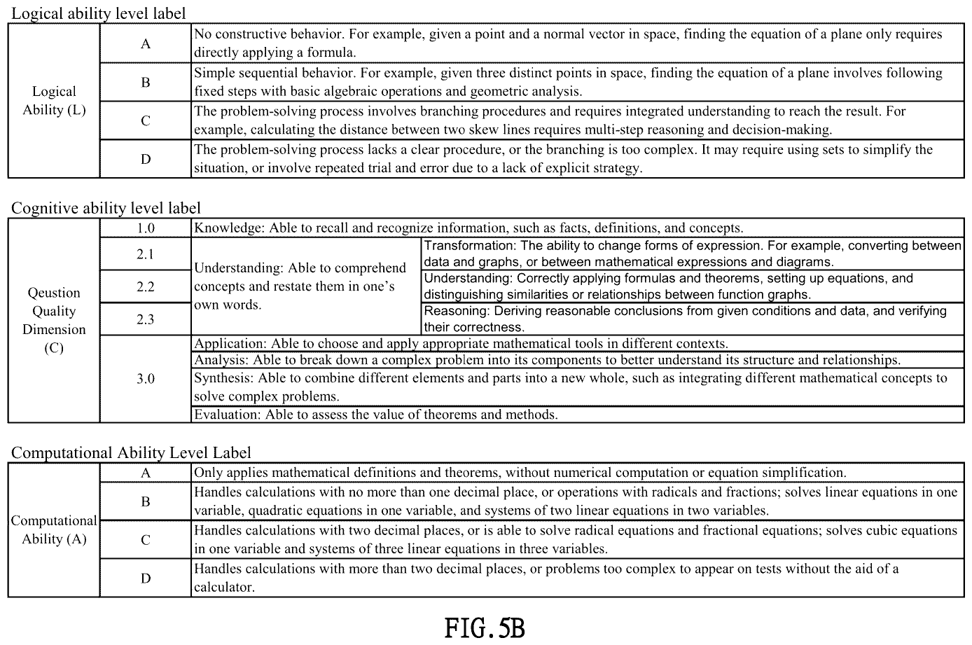

The answer database 10 stores at least one detailed explanation for each question in each test paper. Each detailed explanation includes multiple second operational expressions, a sequence of the second operational expressions, and at least one second answer. When a single question contains multiple detailed explanations and multiple second answers, the number of the second operational expressions is different or the mathematical representation of the second operational expressions is different, and the mathematical representation of the second answers is also different. In one embodiment, the detailed explanation of each question corresponds, based on the second operational expressions, to at least one logical ability level label. As shown in the table of logical ability level labels in FIG. 5B, four types of logical ability levels A to D are defined. If a question only involves applying a corresponding formula for solving, the second operational expressions may include a formula with substitution of numbers or symbols from the question and operational expressions of intermediate steps, and therefore the logical ability level label of the detailed explanation of such a question is A. If another question, such as calculating the distance between two oblique lines, requires more than substituting into a single formula, and the solving process involves branching steps and integration of understanding to obtain the result, the solving process is reflected in multiple second operational expressions and the sequence of the second operational expressions in the detailed explanation, and such a detailed explanation corresponds to the logical ability level label C. Furthermore, depending on the content of a question, the detailed explanation May correspond to multiple logical ability level labels. In addition, as shown in the table of cognitive ability level labels and the table of computational ability level labels in FIG. 5B, different cognitive ability level labels and/or computational ability level labels may be further annotated in the detailed explanation according to the content of each question.

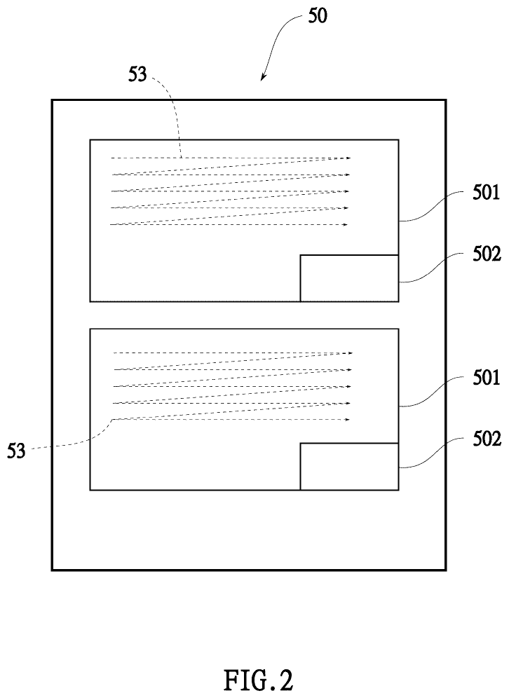

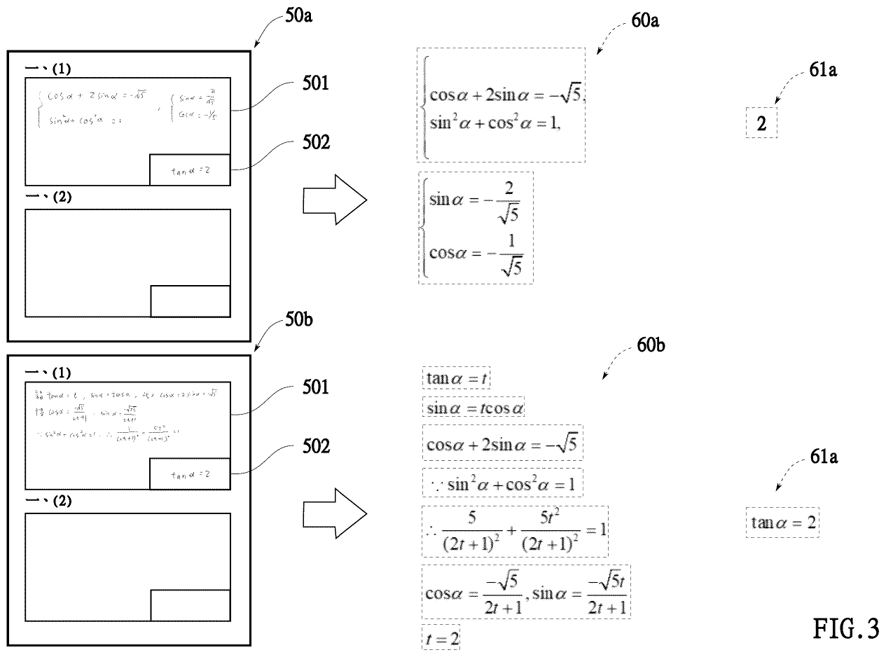

With reference to FIG. 3, the handwritten answer reading interface unit 20 is used to read the answer content of each question on handwritten answer sheets 50a and 50b about mathematics and physics test questions. The answer content includes multiple first operational expressions 60a and 60b, and at least one first answer 61a and 61b. In this embodiment, with reference to FIG. 2, the handwritten answer sheet 50 defines a handwritten area 501 and an answer area 502 for each question. The first operational expressions 60a and 60b corresponding to each question are located in the handwritten area 501, and the first answers 61a and 61b are located in the answer area 502. Therefore, the handwritten answer reading interface unit 20 reads not only the answer content of each question on the handwritten answer sheet 50, but also both the handwritten area 501 and the answer area 502.

The computer device 30 is connected to the answer database 10 and the handwritten answer reading interface unit 20. The computer device 30 is equipped with an automatic grading program, and the automatic grading program includes the following steps (a) to (f).

In step (a), the computer device 30 receives the answer content of each question from the handwritten answer reading interface unit 20. In one embodiment, the handwritten answer sheet 50 about mathematics and physics test questions may be a physical paper answer sheet 51 or an electronic answer sheet 52. When the handwritten answer sheet 50 is the physical paper answer sheet 51, the handwritten answer reading interface unit 20 is an optical reading interface unit that scans the answer content on the physical paper handwritten answer sheet 50. In another embodiment, when the handwritten answer sheet 50 is the electronic answer sheet 52, the handwritten answer reading interface unit 20 can be integrated into the computer device 30, and the computer device 30 directly reads the handwritten answer sheet 50 in an electronic form.

In step (b), the computer device 30 identifies the first operational expressions 60a and 60b of each question, the answering sequence of the first operational expressions 60a and 60b, and the first answers 61a and 61b. In one embodiment, when the computer device 30 receives the physical paper answer sheet 51 scanned by the handwritten answer reading interface unit 20, the computer device 30 converts the answer content in the handwritten area 501 into the first operational expressions 60a and 60b as shown in FIG. 3. The computer device 30 then recognizes the relative answering sequence of the first operational expressions 60a and 60b in accordance with the handwriting direction 53 shown in FIG. 2, for example, from left to right and from top to bottom (not limited to this handwriting direction). The relative answering sequence of the first operational expressions 60a and 60b is marked and stored. In another embodiment, when the computer device 30 receives the electronic answer sheet 52 directly generated and read by the handwritten answer reading interface unit 20, the computer device 30 directly records the time when the first operational expressions 60a and 60b appear in the handwritten answer reading interface unit 20 as the relative answering sequence of the first operational expressions 60a and 60b. Furthermore, with reference to FIG. 1, the computer device 30 can be connected to a network server 40 with a built-in large language model 41, or the computer device 30 can directly integrate a large language model 41. The large language model 41 executes step (b) to more accurately recognize the numbers, symbols, operators, and/or characters of the first operational expressions 60a and 60b and the first answers 61a and 61b.

In step (c), the computer device 30 reads at least one previously stored detailed explanation of the same question from the answer database 10.

In step (d), the computer device 30 compares whether the first operational expressions 60a and 60b and the relative answering sequence of the first operational expressions 60a and 60b match the second operational expressions and the answering sequence of one of the detailed explanations. The computer device 30 then assigns an answering logic score to the question based on the comparison result. In one embodiment, when the computer device executes step (d) to determine the answering logic score, the computer device 30 assigns to the question at least one logical ability level label corresponding to the detailed explanation as shown in FIG. 5B if the first operational expressions 60a and 60b and the relative answering sequence of the first operational expressions 60a and 60b match the second operational expressions and the answering sequence of one of the detailed explanations. One feasible way of assigning the answering logic score is to directly annotate the question with the same logical ability level label. Furthermore, with reference to FIG. 5B, in order to more comprehensively evaluate the answering ability of a student, in addition to determining whether answering logic ability exists, the computer device 30 further determines whether the first operational expressions 60a and 60b conform to the cognitive ability level label and/or the computational ability level label corresponding to the detailed explanation. If conformity exists, the same cognitive ability level label and/or computational ability level label is directly annotated. For example, when the first operational expressions 60a shown in FIG. 3 completely match a first detailed explanation, and the first operational expressions 60b completely match a second detailed explanation, and the second detailed explanation is annotated with a better cognitive ability level label than the first detailed explanation. The cognitive ability level label of the first detailed explanation is 1.0 and the cognitive ability level label of the second detailed explanation is 3.0. When a student answers using the first operational expressions 60b, the student's answering ability is assigned the cognitive ability level label 3.0.

In step (e), the computer device 30 compares whether the first answers 61a and 61b match at least one second answer, and assigns an answer score to the question. Since handwritten answers for mathematics and physics test questions often include various mathematical expressions derived from the use of formulas and calculation processes, the answers may not be a single number or a single expression. Therefore, the computer device 30 determines correctness by comparing whether the first answers 61a and 61b match at least one second answer stored in the answer database 10. As shown in FIG. 3, the answer database may store the second answer as “2” or “tan α=2,” so that both first answers 61a and 61b match the correct answer. In addition, if the answer database is preset with the second answer only as the number “2,” the computer device 30 may connect to a network server 40 with a built-in large language model 41, or directly integrate a large language model 41, to execute step (e). The large language model 41 more accurately recognizes the numbers, symbols, operators, and/or characters of the first operational expressions 60b, and determines that “tan α=2” substantially matches the second answer “2.” Thus, the first answers 61a and 61b are given the same answer score. Furthermore, different expression forms of first answers that are determined by the large language model 41 to substantially match are stored in the answer database 10 and annotated as another form of the second answer.

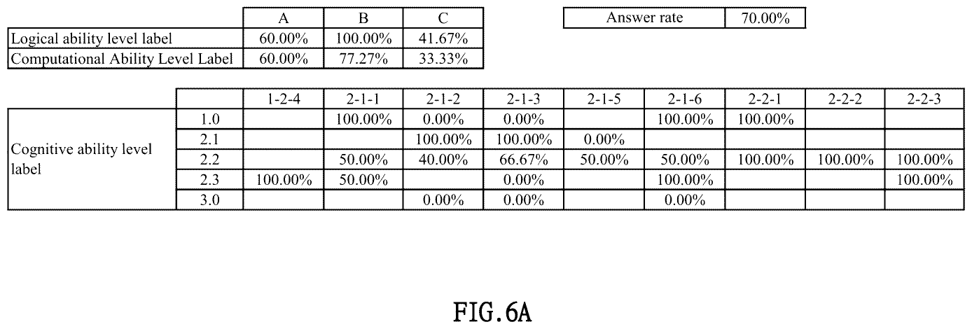

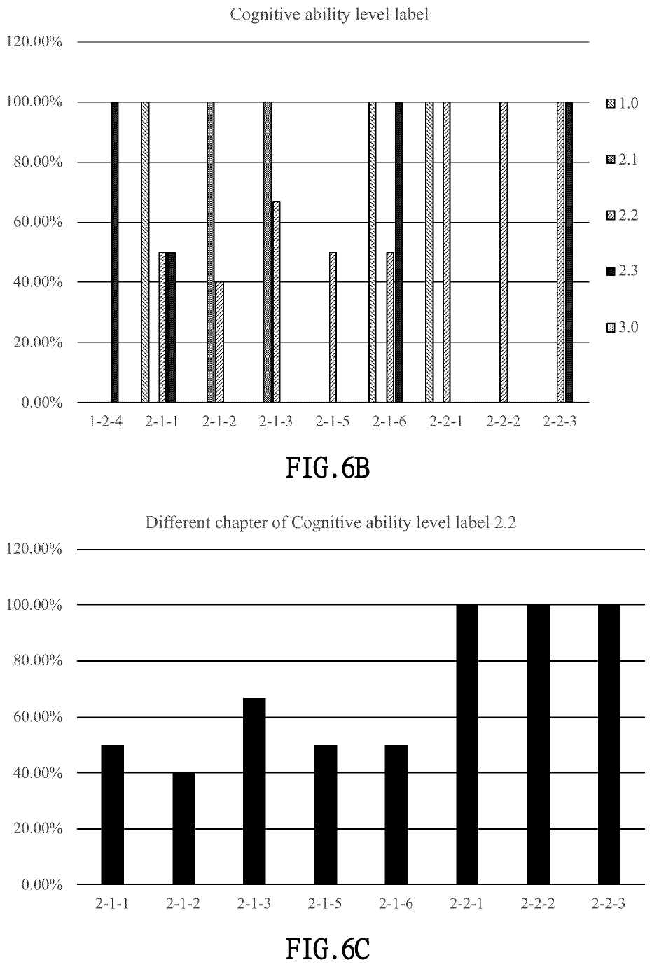

In step (f), the computer device 30 counts and displays the logical ability level labels, cognitive ability level labels, and/or computational ability level labels that are annotated after step (d) determines the answer content of all questions on the handwritten answer sheet 50 about mathematics and physics test questions. These labels are used to determine the answering abilities lacking in the handwritten answer sheet 50. The computer device 30 may further present statistical charts of the answering ability gaps in the handwritten answer sheet 50, as shown in FIGS. 6B and 6C. In addition, each question may be assigned a knowledge point label according to the corresponding textbook unit. All knowledge point labels of the questions can be counted together to identify the weakest knowledge point label in the handwritten answer sheet 50 answered by the student. Questions related to the textbook unit corresponding to the weakest knowledge point label are then selected for the student to answer in order to remedy the student's learning deficiencies.

By further taking a senior high school mathematics course as an example, the determination result of the computational ability level label in step (d) above is explained as follows. Assume the question is: “On a number line, two points A (1.5̅4̅). B (11.9̅3̅) are given. Point P lies on A̅B̅ and A̅P̅:B̅P̅=3:4. Find the coordinate of P.” The student writes “6” in the answer area and writes in the handwritten area as follows:

$$A = 1. \overline{54} = 1 + \frac{54}{99} = 1 + \frac{6}{11} = \frac{17}{11}$$

$$B = 11. \overline{93} = 11 + \frac{93}{99} = 11 + \frac{31}{33} = \frac{394}{33} ⇒ P = \frac{\frac{17}{11} \times 4 + \frac{394}{33} \times 3}{3 + 4} = 6$$

The computer device 30 recognizes multiple first operational expressions (for example, in LaTeX format), beginning with “Solution: $A=1.\overline{54}=1+\frac{54}{99}=1+\frac{6}{11}=\frac{17}{11}$,$B=1 1.\overline{93}=11+\frac{93}{99}=11+\frac{31}{33}=\frac{394}{33}$ $\Rightarrow P=\frac{\frac{17}{11} \times 4+\frac{394}{33} \times 3}{3+4}=6$” and an answer “ANSWER: $6$”. With reference to the answering ability level tables shown in FIGS. 5A and 5B, the computational ability level labels listed in the following table are obtained:

| knowledge | logical ability | cognitive ability | computational |
|---|---|---|---|
| point label | level labels | level label | ability level label |
| 1-1-2 | B | 2.2 | C |
| 1-3-1 | B | 2.2 | C |

Accordingly, as shown in FIG. 6A, the computer device 30 compiles the matching rates and answer rates of the logical ability level labels, cognitive ability level labels, and computational ability level labels that are annotated for the answer content of all questions on the handwritten answer sheet 50 (the scope of questions covers chapters 1-1-1 to 2-2-4 as shown in FIG. 5A). Based on the statistical table in FIG. 6A, the computer device 30 further generates, as shown in FIG. 6B, the matching rates between the knowledge point labels of each chapter annotated for all questions and the logical ability level labels, cognitive ability level labels, and computational ability level labels. The statistical result indicates poor cognitive ability by the student in many chapters. Therefore, as shown in FIG. 6C, the computer device 30 further compiles the matching rates of cognitive ability level label 2.2 (understanding ability) under the annotated knowledge point labels (chapters). The compiled result quickly reveals that the student's understanding is weakest in chapters 2-1-1, 2-1-2, 2-1-5, and 2-2-6, thereby confirming learning gaps in chapters 2-1-1, 2-1-2, 2-1-5, and 2-2-6.

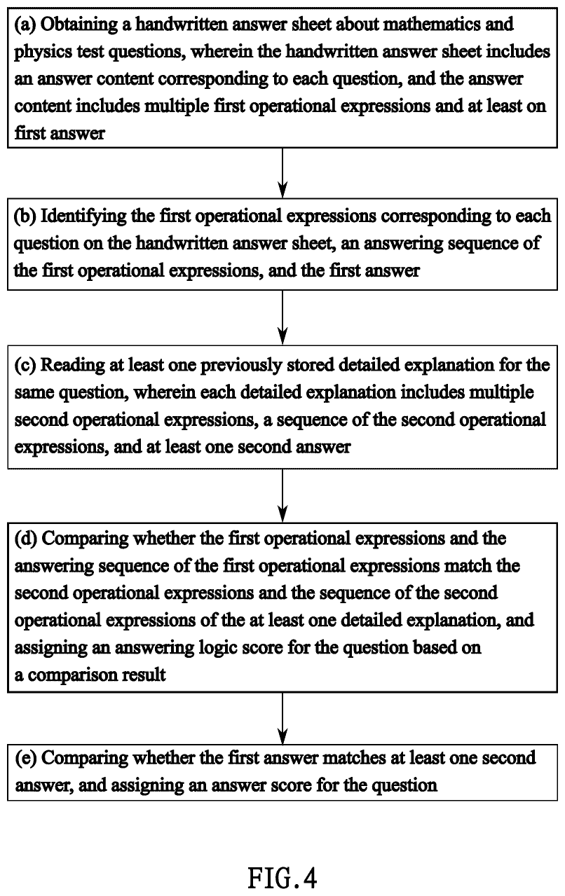

From the foregoing, the technical content of the answering ability assessment system for the handwritten answer sheet 50 about mathematics and physics test questions is clear. Furthermore, the following method for assessing answering ability from the handwritten answer sheet 50 about mathematics and physics test questions can be organized. The method includes steps (a) to (e) as shown in FIG. 4, and may further include step (f).

Step (a) obtains a handwritten answer sheet 50 about mathematics and physics test questions. The handwritten answer sheet 50 includes answer content corresponding to each question. With reference to FIG. 3, the answer content includes multiple first operational expressions 60a and 60b and a first answer 61a and 61b. In this embodiment, with reference to FIG. 2, the handwritten answer sheet 50 defines, for each question, a handwritten area 501 and an answer area 502. The first operational expressions 60a and 60b corresponding to each question are located in the handwritten area 501, and the first answers 61a and 61b are located in the answer area 502. In one embodiment, the handwritten answer sheet 50 is a physical paper answer sheet 51 or an electronic answer sheet 52.

Step (b) identifies the first operational expressions 60a and 60b corresponding to each question on the handwritten answer sheet 50, the answering sequence of the first operational expressions 60a and 60b, and the first answers 61a and 61b. In this embodiment, the answer content in the handwritten area 501 of the handwritten answer sheet 50 is identified as the first operational expressions 60a and 60b, and the answer content in the answer area 502 is identified as the first answers 61a and 61b. In one embodiment, when the handwritten answer sheet 50 is the physical paper answer sheet 51, an optical scanner scans the handwritten area 501 on the physical paper answer sheet 51, converts the answer content of the handwritten area 501 into the first operational expressions 60a and 60b, and, in accordance with a handwriting direction 53 (as shown in FIG. 2), for example from left to right and from top to bottom, records and stores the relative answering sequence of the first operational expressions 60a and 60b. In another embodiment, when the handwritten answer sheet 50 is the electronic answer sheet 52, an electronic device that generates the electronic answer sheet 52 records the first operational expressions 60a and 60b in each handwritten area 501, and records and stores the time when the first operational expressions 60a and 60b appear in the electronic device as the relative answering sequence of the first operational expressions 60a and 60b. In one embodiment, the first operational expressions and the first answers are recognized by a large language model with respect to one or a combination of numbers, symbols, operators, and characters.

Step (c) reads at least one previously stored detailed explanation for the same question. Each detailed explanation includes multiple second operational expressions, a sequence of the second operational expressions, and at least one second answer. When a single question includes multiple detailed explanations and multiple second answers, the number of the second operational expressions is different or the mathematical representation of the second operational expressions is different, and the mathematical representation of the second answers is also different. As described for the answer database 10 above, the detailed explanation of each question corresponds, based on the second operational expressions, to at least one logical ability level label, cognitive ability level label, and/or computational ability level label.

Step (d) compares whether the first operational expressions 60a and 60b and the relative answering sequence of the first operational expressions 60a and 60b match the second operational expressions and the answering sequence of one of the detailed explanations, and assigns an answering logic score to the question based on the comparison result. In one embodiment, one way of assigning the answering logic score in step (d) is that, when the first operational expressions 60a and 60b and the relative answering sequence of the first operational expressions 60a and 60b match the second operational expressions and the answering sequence of one of the detailed explanations, the computer device assigns to the question at least one logical ability level label corresponding to the detailed explanation as shown in FIG. 5B. One feasible way of assigning the answering logic score is to directly annotate the question with the same logical ability level label. Furthermore, in order to more comprehensively evaluate the answering ability of a student, in addition to determining whether answering logic ability exists, the computer device further determines whether the first operational expressions 60a and 60b conform to the cognitive ability level label and/or the computational ability level label corresponding to the detailed explanation. In one embodiment, if the first answer does not match the previously stored second answer, the first answer is further transmitted to a large language model. The large language model further determines whether the first answer substantially matches the second answer. If so, the first answer is regarded as correct, and the first answer is stored and annotated as another form of the second answer.

Step (e) compares whether the first answers 61a and 61b substantially match at least one second answer, and assigns an answer score to the question. Since handwritten answers for mathematics and physics test questions are often expressed in many different mathematical forms arising from the use of formulas and intermediate calculations, a first answer may not be a single number or a single expression. Therefore, correctness is determined by comparing whether the first answers 61a and 61b match at least one second answer in the answer database 10.

Step (f) compiles and displays the logical ability level labels, cognitive ability level labels, and computational ability level labels that are annotated for the answer content of all questions on the handwritten answer sheet 50 after the determination in step (d). The compiled labels are used to determine mathematics-related answering abilities lacking from the handwritten answer sheet 50. Step (f) may further present statistical charts showing answering ability gaps of the handwritten answer sheet 50, as shown in FIGS. 6B and 6C. In addition, each question may be assigned a knowledge point label according to the textbook unit. All knowledge point labels of all questions may be aggregated to identify the weakest knowledge point label in the handwritten answer sheet 50 answered by the student. Questions corresponding to the textbook unit content associated with the weakest knowledge point label are then selected for the student to answer, in order to remedy the student's learning deficiencies.

In conclusion, the method for assessing answering ability from a handwritten answer sheet for mathematics and physics test questions mainly operates by obtaining a student's handwritten answer sheet, identifying for each question multiple first operational expressions, a relative answering sequence of the first operational expressions, and a first answer, and using, in conjunction, multiple previously stored detailed explanations and at least one second answer corresponding to the question. Each detailed explanation includes multiple second operational expressions, an answering sequence of the second operational expressions, and at least one second answer. Accordingly, when multiple identified first operational expressions and the relative answering sequence match multiple second operational expressions and the answering sequence of one detailed explanation, the question is assigned an answering logic score. When an identified first answer conforms to one second answer, the question is assigned an answer score. Thus, the method effectively and objectively evaluates the student's actual answering performance on the handwritten answer sheet and records and monitors the learning progress. In addition, the method prevents cheating by a student who copies only a correct first answer while listing meaningless operational expressions and calculation processes, thereby avoiding an undeserved score and avoiding omission in assessing the student's answering ability.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method for assessing answering ability from a handwritten answer sheet for mathematics and physics test questions, implemented by a computer device executing the following steps of:
(a) obtaining a handwritten answer sheet for mathematics and physics test questions, wherein the handwritten answer sheet includes answer content corresponding to each question, and the answer content includes multiple first operational expressions and at least on first answer;
(b) identifying the first operational expressions corresponding to each question on the handwritten answer sheet, an answering sequence of the first operational expressions, and the first answer;
(c) reading at least one previously stored detailed explanation for the same question, wherein each detailed explanation includes multiple second operational expressions, a sequence of the second operational expressions, and at least one second answer, and when a single question includes multiple detailed explanations and multiple second answers, numbers of the second operational expressions are different or mathematical representation forms of the second operational expressions are different, and mathematical representation forms of the second answers are also different;
(d) comparing whether the first operational expressions and the answering sequence of the first operational expressions match the second operational expressions and the sequence of the second operational expressions of the at least one detailed explanation, and assigning an answering logic score for the question based on a comparison result; and
(e) comparing whether the first answer matches at least one second answer, and assigning an answer score for the question.

2. The method as claimed in claim 1, wherein:
in the step (a), the handwritten answer sheet for mathematics and physics test questions defines a handwritten area and an answer area for each question, wherein first operational expressions corresponding to each question are located in the handwritten area and the first answer corresponding to each question is located in the answer area; and
in the step (b), the answer content in the handwritten area of the handwritten answer sheet for mathematics and physics test questions is identified as the first operational expressions, and the answer content in the answer area is identified as the first answer.

3. The method as claimed in claim 2, wherein, in the step (b), the answering sequence of the first operational expressions in the handwritten area is identified in accordance with a handwriting direction.

4. The method as claimed in claim 3, wherein the handwriting direction is from left to right and from top to bottom.

5. The method as claimed in claim 1, wherein:
in the step (c), each detailed explanation corresponds to at least one logical ability level label based on the second operational expressions; and
in the step (d), when the first operational expressions and the answering sequence of the first operational expressions match the second operational expressions and the answering sequence of at least one detailed explanation, at least one logical ability level label corresponding to the detailed explanation is assigned as the answering logic score for the question.

6. The method as claimed in claim 5, wherein:
in the step (c), each detailed explanation further corresponds to a cognitive ability level label or a computational ability level label based on the second operational expressions; and
in the step (d), when the first operational expressions and a relative answering sequence of the first operational expressions match the second operational expressions and the answering sequence of at least one detailed explanation, the same cognitive ability level label or the same computational ability level label is directly annotated.

7. The method as claimed in claim 6, further comprising a step of:
(f) compiling and displaying the logical ability level labels, the cognitive ability level labels, and the computational ability level labels that are annotated for the answer content of all questions on the handwritten answer sheet for mathematics and physics test questions after the determination in step (d).

8. The method as claimed in claim 3, wherein:
in the step (a), the handwritten answer sheet for mathematics and physics test questions is a physical paper answer sheet; and
in the step (b), an optical scanner scans the handwritten area on the physical paper answer sheet, converts the answer content in the handwritten area into the first operational expressions in accordance with the handwriting direction, and records and stores the answering sequence of the first operational expressions.

9. The method as claimed in claim 2, wherein:
in the step (a), the handwritten answer sheet for mathematics and physics test questions is an electronic answer sheet; and
in the step (b), an electronic device that generates the electronic answer sheet records the first operational expressions in each handwritten area, and records and stores a time when the first operational expressions appear in the electronic device as the answering sequence.

10. The method as claimed in claim 8, wherein:
in step (b), the first operational expressions and the first answer are recognized by a large language model with respect to one or a combination of numbers, symbols, operators, and characters; or
in step (e), when the first answer does not match a previously stored second answer, the first answer is transmitted to the large language model, the large language model determines whether the first answer substantially matches the second answer, and, if substantial matching is determined, the first answer receives the same answer score and the first answer is stored and annotated as another form of the second answer.

11. A system for assessing answering ability from a handwritten answer sheet for mathematics and physics test questions comprising:
an answer database configured to store, for each question in each test paper, at least one detailed explanation, wherein each detailed explanation includes multiple second operational expressions, a sequence of the second operational expressions, and at least one second answer, and when a single question includes multiple detailed explanations and multiple second answers, a number of the second operational expressions is different or a mathematical representation of the second operational expressions is different, and a mathematical representation of the second answers is also different;
a handwritten answer reading interface unit configured to read an answer content of each question from a handwritten answer sheet for mathematics and physics test questions, and the answer content including multiple first operational expressions and a first answer; and
a computer device connected to the answer database and the handwritten answer reading interface unit, the computer device including an automatic grading program that executes steps of:
(a) receiving the answer content of each question from the handwritten answer reading interface unit;
(b) identifying the first operational expressions in the answer content, identifying an answering sequence of the first operational expressions, and identifying the first answer;
(c) reading at least one previously stored detailed explanation of the same question from the answer database;
(d) comparing whether the first operational expressions and the answering sequence of the first operational expressions match the second operational expressions and the answering sequence of the at least one detailed explanation, and assigning an answering logic score for the question based on a comparison result; and
(e) comparing whether the first answer matches the at least one second answer, and assigning an answer score for the question.

12. The system as claimed in claim 11, wherein:
the handwritten answer sheet for mathematics and physics test questions defines a handwritten area and an answer area for each question, wherein first operational expressions corresponding to each question are located in the handwritten area and the first answer corresponding to each question is located in the answer area;
the handwritten answer reading interface unit reads the handwritten area and the answer area; and
the computer device identifies the answer content in the handwritten area as the first operational expressions and identifies the answer content in the answer area as the first answer.

13. The system as claimed in claim 12, wherein, when executing the step (b), the computer device identifies the answering sequence of the first operational expressions in the handwritten area in accordance with a handwriting direction.

14. The system as claimed in claim 13, wherein the handwriting direction is from left to right and from top to bottom.

15. The system as claimed in claim 11, wherein:
each detailed explanation stored in the answer database corresponds to at least one logical ability level label based on the second operational expressions; and
when executing step (d), if the first operational expressions and the answering sequence of the first operational expressions match the second operational expressions and the answering sequence of one detailed explanation, the computer device assigns at least one logical ability level label corresponding to the detailed explanation as an answering logic score for the question.

16. The system as claimed in claim 15, wherein:
each detailed explanation stored in the answer database further corresponds to a cognitive ability level label or a computational ability level label based on the second operational expressions; and
when executing step (d), if the first operational expressions and the answering sequence of the first operational expressions match the second operational expressions and the answering sequence of one detailed explanation, the computer device annotates the question with the same cognitive ability level label or the same computational ability level label corresponding to the detailed explanation.

17. The system as claimed in claim 16, wherein the automatic grading program further includes a step of: (f) compiling and displaying the logical ability level labels, the cognitive ability level labels, and the computational ability level labels that are annotated for the answer content of all questions on the handwritten answer sheet for mathematics and physics test questions after the determination in step (d).

18. The system as claimed in claim 13, wherein:
the handwritten answer reading interface unit is an optical reading interface unit that scans a physical paper handwritten answer sheet for mathematics and physics test questions; and
when executing step (b), the computer device converts answer content in the handwritten area into the first operational expressions and records a relative answering sequence of the first operational expressions in accordance with the handwriting direction.

19. The system as claimed in claim 12, wherein:
the handwritten answer reading interface unit is integrated into the computer device to directly read a handwritten answer sheet for mathematics and physics test questions in an electronic form; and
when executing step (b), the computer device directly records a time when the first operational expressions appear in the handwritten answer reading interface unit as the answering sequence of the first operational expressions.

20. The system as claimed in claim 18, wherein:
the computer device connects to a network server with a built-in large language model, or directly integrates a large language model, and the large language model executes step (b) to recognize one or a combination of numbers, symbols, operators, and characters of the first operational expressions and the first answer; or
when executing step (e), if the first answer does not match a second answer stored in the answer database, the first answer is transmitted to the large language model, the large language model determines whether the first answer substantially matches the second answer, and, if substantial matching is determined, the first answer receives the same answer score and the first answer is stored in the answer database in a corresponding detailed explanation and annotated as another form of the second answer.
